(19) United States
(12) Patent Application Publication
(10) Pub. No.: US 2015/0108251 A1
(43) Pub. Date: Apr. 23, 2015

(54) MULTICOMPONENT CARTRIDGE, DISPENSING DEVICE FOR A MULTICOMPONENT CARTRIDGE AND SYSTEM FOR MIXING AND SPRAYING FLOWABLE COMPONENTS

(71) Applicants: Jorge Müller, Niederglatt (CH); Richard Lavelanet, Balgach (CH)

(72) Inventors: Jorge Müller, Niederglatt (CH); Richard Lavelanet, Balgach (CH)

(73) Assignee: SULZER MIXPAC AG, Haag (CH)

(21) Appl. No.: 14/400,981

(22) PCT Filed: Apr. 22, 2013
(86) PCT No.: PCT/EP2013/058280

§ 371 Date: Nov. 13, 2014

(30) Foreign Application Priority Data
May 14, 2012 (EP) 12167891.6

(51) Int. Cl. B05B 7/24

(52) U.S. Cl. CPC B05B 7/2497
USPC 239/304

(57) ABSTRACT

The invention relates to a multi-component cartridge, a dispensing device for a multi-component cartridge, and a system for mixing and spraying flowable components. According to the invention, the multi-component cartridge (10) has a cartridge compressed-air channel (20) that is guided along two containers (11, 12) and that has a cartridge compressed-air inlet (21) and a cartridge compressed-air outlet, so that the multi-component cartridge, the dispensing device, and the system for mixing and spraying flowable components can be used easily and safely even in locations that are difficult to access. The containers (11, 12) are used to hold two components to be mixed. By means of the cartridge compressed-air channel (20), compressed air, which is fed in particular by means of a coupling of the cartridge compressed-air inlet (21) to a device compressed-air outlet of a dispensing device, can be conducted to the cartridge compressed-air outlet, which can be connected for example to a mixer compressed-air inlet of a downstream spray mixer (22). The two containers (11, 12) and the cartridge compressed-air channel (20) are formed as one piece.

The invention relates to a multicomponent cartridge in accordance with the preamble of claim 1, to a dispensing device for a multicomponent cartridge in accordance with the preamble of claim 9 and to a system for mixing and spraying flowable components in accordance with the preamble of claim 11.

A system for outputting flowable components is described in the WO 95/31138 A1 and the EP 2 000 215 A2, the system having a multicomponent cartridge and a dispensing device for the multicomponent cartridge. The system has two separate cartridges for receiving two components, with the cartridges being arranged in parallel to one another and adjacent to one another. The system also has a separate compressed air line which is arranged between the cartridges.

A system for outputting flowable components is described in the US 2004/0059283 A1 having a multicomponent cartridge and a dispensing device for the multicomponent cartridge. The system has two separate cartridges for receiving two components, with the cartridges being arranged in parallel to one another and adjacent to one another. The system also has a separate compressed air line which is arranged in sections extending in parallel to the cartridges.

A system for mixing and spraying flowable components is described in US 2011/0081499 A1 having a multicomponent cartridge and a dispensing device for the multicomponent cartridge. The multicomponent cartridge has a first container for receiving a first component and a second container for receiving a second component. Both containers each have a cartridge outlet opening via which the components can exit the containers. The multicomponent cartridge can be inserted into a receiver element of the dispensing device. The dispensing device has a first actuation element for a first piston of the first container and a second actuation element for a second piston of the second container. The pistons can be displaced in the direction of the cartridge outlet opening by means of the actuation elements and the components can thus be urged out of the containers. The components are conducted to a mixing apparatus via two flexible hoses. The mixing apparatus has a handle for holding the mixing apparatus and a spray mixer in which the components are mixed prior to the spraying. Compressed air which is conducted via a separate passage for compressed air extending next to the spray mixer to a distal mixer end of the spray mixer is supplied to the mixer apparatus via a compressed air line not described further. The mixed components can be sprayed out of a mixer outlet opening while utilizing the compressed air.

Such systems for mixing and spraying flowable components are in particular used for the application of coatings in the maintenance of ship hulls, pipelines and steel constructions such as bridges. It is also necessary in this respect to coat points with difficult access. It can occur in the coating of such points that hoses or lines of the coating system get caught at projections of the component to be coated. In this respect, on the one hand, the named hoses and lines may be damaged, which results in the failure of the coating system and thus in repair costs and delays in the maintenance work. On the other hand, an operator of the coating system has to work very carefully and thus also slowly at tight points, which can result in a high time effort, and thus also cost effort, in the use of the coating system.

In view of this, it is in particular the object of the invention to provide a multicomponent cartridge, a dispensing device for a multicomponent cartridge and a system for mixing and spraying flowable components which is easy to handle. In accordance with the invention, the object is satisfied by a multicomponent cartridge having the features of claim 1, by a dispensing device for a multicomponent cartridge having the features of claim 9 and by a system for mixing and spraying flowable components having the features of claim 11.

The multicomponent cartridge has a cartridge passage for compressed air which is guided along the container and has a cartridge inlet for compressed air and a cartridge outlet for compressed air. Compressed air, which is in particular supplied via a coupling of the cartridge inlet for compressed air to a device outlet for compressed air of a dispensing device, can be conducted via the cartridge passage for compressed air to the cartridge outlet for compressed air which can be connected, for example, to a mixer inlet for compressed air of a downstream spray mixer.

The cartridge passage for compressed air is thus an integral component of the multicomponent cartridge. No separate compressed air hose is therefore necessary with which the compressed air is conducted to the spray mixer. The multicomponent cartridge, and thus also the whole system for mixing and spraying flowable components, thus has few separate components such as hoses which can catch one another at some point. The risk that the system for mixing and spraying flowable components in which the multicomponent cartridge in accordance with the invention is used is damaged during operation is thus very small.

In accordance with the invention, the first container, the second container and the cartridge passage for compressed air are made in one piece. No separate assembly of the two containers and of the cartridge passage for compressed air is thus necessary in the manufacture of the multicomponent cartridge. An inexpensive manufacture of the multicomponent cartridge is thus made possible. Additionally the multicomponent cartridge is only made of one piece so a transport, a storage and an insertion into the dispensing device is easy.

The multicomponent cartridge can also have more than two containers with components, for example three or four containers with components, which can be mixed and sprayed. “Compressed air” is here to be understood as a gaseous atomization medium. The atomization medium is in particular air; an inert gas such as nitrogen or carbon dioxide can, however, also be used, for example. The spray mixer can be designed as a so-called dynamic mixer and in particular as a so-called static mixer. A dynamic mixer has a rotating mixing element for mixing the components; a static mixer has a fixed-position mixing element which allows an efficient mixing of the components due to its special geometry.

In an embodiment of the invention, the first container is cylindrical and has a first cylinder axis and the second container is likewise cylindrical and has a second cylinder axis, with the two containers being arranged paraxially next to one another. The multicomponent cartridge is thus designed as a so-called side-by-side cartridge. The cartridge passage for compressed air is arranged between the first and second cylinder axes. “Between” in this sense is not to be understood such that the cartridge passage for compressed air is arranged on a connection line between the two cylinder axes. It can also be arranged at a spacing from the named connection line. The cartridge passage for compressed air can in particular be connected to both containers and can thus be fixed.

The first container and the second container are in particular arranged so that a notch extending in parallel to the cylinder axes is formed between them. The two containers are therefore arranged in a spacing from one another which is as small as possible. The cartridge passage for compressed air is then arranged in the named notch. The cartridge passage for compressed air is in this case arranged particularly protected between the two containers so that the risk that the cartridge passage for compressed air catches somewhere is particularly small. This is in particular the case since the cartridge passage for compressed air usually has a much smaller diameter than the two containers and it can thus be arranged completely in the named notch.

In an embodiment of the invention, the first container and the second container have filling openings which are closed by the piston for dispensing the components after the filling with the respective component has taken place. The two filling openings and the cartridge inlet for compressed air are arranged in one plane. A particularly simple connection to the dispensing device is thus possible since the associated connections can also be arranged in one plane. In addition, the multicomponent cartridge can be produced particularly simply in this case.

In an embodiment of the invention, the first container, the second container and the cartridge passage for compressed air are made from plastic. The multicomponent cartridge thus has a particularly low weight and can also be manufactured inexpensively. The components can be composed of, for example, polypropylene, polyamide, polycaprolactam (polyamide 6) or polybutylene terepththalate). Other suitable plastics are, however, also possible.

The manufacture of the one-piece component in particular takes place by means of an injection molding process. It can thus be manufactured simply in very large volumes and particularly inexpensively.

In an embodiment of the invention, the multicomponent cartridge has a cartridge outlet connector to which a spray mixer for mixing the components can be connected. The cartridge outlet connector surrounds the at least one cartridge outlet opening and additionally the cartridge outlet for compressed air. Both the connections for the components to be mixed and the connection for the compressed air can thus be established via the one cartridge outlet connector, which allows a particularly simple handling of the multicomponent cartridge since the spray mixer and the compressed air can be connected in one workstep. For this purpose an especially designed spray mixer is necessary which has a mixer passage for compressed air having a mixer inlet for compressed air and a mixer outlet for compressed air.

In an embodiment of the invention, the cartridge outlet connector has separate container outlet openings for the first and second containers. A particularly effective mixing of the two components in the downstream spray mixer is thus made possible.

The object is satisfied in accordance with the invention by a dispensing device for a multicomponent cartridge having a receiver element for a multicomponent cartridge having a first container for receiving a first flowable component and a second container for receiving a second flowable component. The dispensing device has a first actuation element for a first piston of the first container and a second actuation element for a second piston of the second container. It furthermore has a device passage for compressed air having a device inlet for compressed air and a device outlet for compressed air which is designed so that it can be connected to a cartridge inlet for compressed air of the multicomponent cartridge.

The first actuation element in particular has a first actuation rod and the second actuation element has a second actuation rod, with the device outlet for compressed air being arranged between the first actuation rod and the second actuation rod. “Between” in this sense is not to be understood such that the device passage for compressed air is arranged on a connection line between the two actuation rods. It can also be arranged at a spacing from the named connection line.

The object is moreover satisfied in accordance with the invention by a system for mixing and spraying flowable components. The system has a multicomponent cartridge having a first container for receiving a first component, a second container for receiving a second component and at least out outlet opening via which the components can exit the containers. The system moreover has a dispensing device, with a receiver element for the multicomponent cartridge, a first actuation element for a first piston of the first container and a second actuation element for a second piston of the second container. The system additionally has a spray mixer connected to the outlet opening of the multicomponent cartridge. The multicomponent cartridge has a cartridge passage for compressed air having a cartridge inlet for compressed air and a cartridge outlet for compressed air and the dispensing device has a device passage for compressed air having a device inlet for compressed air and a device outlet for compressed air, with the cartridge inlet for compressed air and the device outlet for compressed air being designed so that they are connected to one another when the multicomponent cartridge is inserted into the receiver element of the dispensing device.

The spray mixer can in this respect in particular be directly connected to the cartridge outlet connector of the multicomponent cartridge. It is, however, also possible that the connection takes place by means of a suitable connection element, for example in the form of suitable hoses.

The mixer inlet for compressed air is in particular arranged at the mixer start. The mixer passage for compressed air thus extends from the mixer start to the mixer end along the spray mixer. In the region of the spray mixer, the latter is arranged at the multicomponent cartridge and projects away from it. No compressed air feed to the mixer end and thus no hose to the mixer end is necessary due to the arrangement of the mixer inlet for compressed air at the mixer start. The spray mixer can thus also be introduced into tight intermediate spaces without there being any risk of a compressed air hose catching anywhere.

An inner mixer housing which receives the mixing element is in particular arranged inside the outer mixer housing. The mixer passage for compressed air is formed between the inner mixer housing and the outer mixer housing. The outer mixer housing and the inner mixer housing are therefore designed so that an intermediate space is formed between the two in the assembled state which is used as a mixer passage for compressed air. A particularly simple design of the spray mixer thus results.

It is, however, also possible that the passage for compressed air is designed differently. It can, for example, be designed as a separate tube which extends in parallel to the outer mixer housing.

In an embodiment of the invention, the spray mixer has a mixer inlet connector which is arranged at the mixer start and which can be connected to the cartridge outlet connector of a multicomponent cartridge. The mixer inlet connector has at least one mixer inlet opening via which the components can be supplied. It moreover includes the mixer inlet for compressed air. Both the connections for the components to be mixed and the connection for the compressed air can thus be established via the one mixer inlet connector, which allows a particularly simple handling of the spray mixer since only one workstep is necessary for connecting the spray mixer to the multicomponent cartridge.

The mixer inlet connector is in particular oriented in the direction of the longitudinal mixer axis. It is to be understood by this that the components and the compressed air flow in the direction of the longitudinal mixer axis through the mixer inlet connector. A particularly compact design of the spray mixer is thus achieved.

The mixing element is in particular designed as a static mixing element. In contrast to a dynamic mixer which has a rotating mixing element for mixing the components, a static mixer has a fixed-position mixing element which allows an efficient mixing of the components due to its special geometry. This allows a particularly inexpensive design of the spray mixer.

The mixing element and the mixer inlet connector are in particular made in one piece. The spray mixer thus has particularly few individual parts, which makes its manufacture and its assembly particularly simple and inexpensive.

It is, however, possible that the mixing element and the mixer inlet connector are made as two separate components.

The outer mixer housing, the inner mixer housing and the mixing element are in particular made of plastic. The spray mixer thus has a particularly low weight and can also be manufactured inexpensively. The above-named plastics can likewise be used for this purpose.

The manufacture of the outer mixer housing, of the inner mixer housing and of the mixing element in particular takes place by means of an injection molding process. The components can thus be manufactured simply in very large volumes and particularly inexpensively.

Further advantages, features and details of the invention result with reference to the following description of embodiments and with reference to drawings in which elements which are the same or have the same function are provided with identical reference numerals.

There are shown:

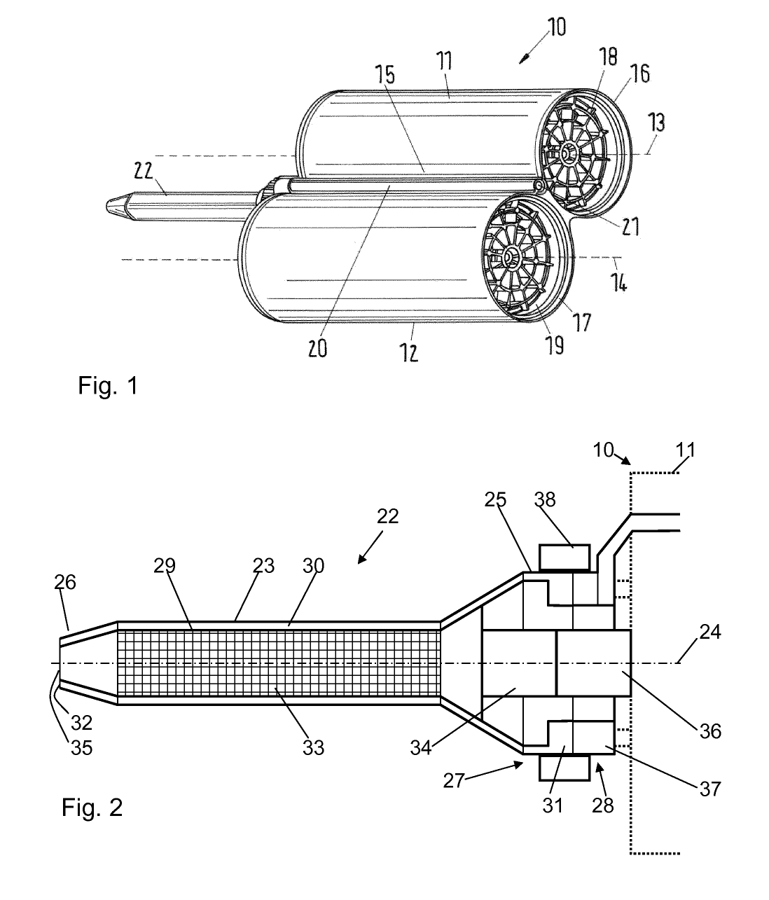

FIG. 1 a multicomponent cartridge for receiving flowable components with a spray mixer plugged on;

FIG. 2 a spray mixer connected to a multicomponent cartridge; and

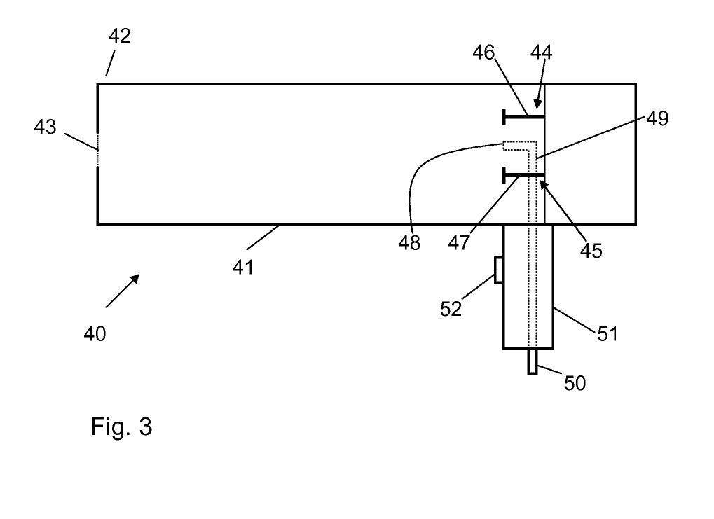

FIG. 3 a dispensing device for a multicomponent cartridge of FIG. 1.

In accordance with FIG. 1, a multicomponent cartridge 10 has a first container 11 for receiving a first component and a second container 12 for receiving a second component. The first and second containers 11, 12 have a cylindrical base shape having a first cylinder axis 13 and a second cylinder axis 14. The two containers 11, 12 are arranged paraxially next to one another. The containers 11, 12 are connected to one another and have a minimal spacing from one another. A notch 15 thus results between the two containers which extends in parallel to the two cylinder axes 13, 14. The multicomponent cartridge 10 is thus designed as a so-called side-by-side cartridge. The containers 11, 12 of the multicomponent cartridge 10 have the same diameter. A mixing ratio of the components on the dispensing from the containers 11, 12 thus amounts to 1:1. Other diameters, and thus mixing ratios, are also possible however, such as 1:2, 1:4, 1:10 or higher.

At an end face of the containers 11, 12 they each have a filling opening 16, 17 which extends over the total end face of the containers 11, 12. The containers 11, 12 can be filled with a corresponding flowable component via the filling openings 16, 17. The filling openings 16, 17 are closed by a respective piston 18, 19 in the representation of FIG. 1. The pistons 18, 19 are inserted after the filling of the containers 11, 12. The components can be dispensed by displacing the pistons 18, 19 away from the filling openings 16, 17 via two cartridge outlet openings which are arranged at a side of the multicomponent cartridge 10 disposed opposite the filling openings 16, 17. The cartridge outlet openings cannot be seen in the representation of FIG. 1.

A cartridge passage for compressed air 20 runs in the notch 15 between the two containers 11, 12. The cartridge passage for compressed air 20 has a circular cross-section and extends from a cartridge inlet for compressed air 21 to a cartridge outlet for compressed air not shown in FIG. 1. The cartridge inlet for compressed air 21 is arranged in a plane with the filling openings 16, 17 of the containers 11, 12. The cartridge outlet for compressed air is located in the area of the cartridge outlet openings. The cartridge passage for compressed air 20 thus extends over the total length of the containers 11, 12 and thus also of the multicomponent cartridge 10.

The first container 11, the second container 12 and the passage for compressed air 20 are made in one piece. In addition, no separate component are likewise required for the cartridge outlet openings, not shown, and the cartridge outlet for compressed air so that the total multicomponent cartridge 10 is thus made in one piece. The multicomponent cartridge 10 is manufactured from plastic by means of an injection molding process. Polypropylene, polyamide, polycaprolactam (polyamide 6) or polybutylene terepththalate can be used for this purpose.

A spray mixer 22 is arranged on the side of the multicomponent cartridge 10 disposed opposite the filling openings 16, 17. The spray mixer 22 is connected via a cartridge outlet connector, not shown in FIG. 1, to the multicomponent cartridge 10 such that connections arise to the cartridge outlet openings and to the cartridge outlet for compressed air. The components dispensed from the containers 11, 12 are mixed by the spray mixer 22 and are atomized and sprayed by means of the compressed air supplied via the cartridge passage for compressed air 20. The design of the spray mixer 22 is shown more precisely in FIG. 2.

The spray mixer 22 for mixing and spraying at least two flowable components is shown in a sectional representation in FIG. 2. The section runs in parallel to the cylinder axes 13, 14 between the two containers 11, 12 with respect to FIG. 1. A small part of the multicomponent cartridge 10 is moreover shown in FIG. 2. A part of the container 11 of the multicomponent cartridge 10 which lies behind the section plane is shown dotted for better understanding.

The spray mixer 22 has a mainly tubular outer mixer housing 23 which extends in the direction of a longitudinal mixer axis 24 from a mixer start 25 up to a distal mixer end 26. The spray mixer 22 is connected to the multicomponent cartridge 10 at the mixer start 25.

The outer mixer housing 23 has a constant cross-section in a middle region and tapers a little toward the mixer end 26. The outer mixer housing 23 widens toward the mixer start 25 at the opposite side and forms a part of a mixer inlet connector 27 by means of which the spray mixer 22 is connected to a cartridge outlet connector 28 of the multicomponent cartridge 10.

An inner mixer housing 29 is arranged within the outer mixer housing 23 and has an outer contour corresponding to the contour of the outer mixer housing 23 so that a ring-shaped hollow space which serves as a mixer passage for compressed air 30 results between the outer mixer housing 23 and the inner mixer housing 29. Compressed air can be supplied to the mixer passage for compressed air 30 via a mixer inlet for compressed air 31 which likewise forms a part of the mixer inlet connector 27. The mixer inlet for compressed air 31 is thus arranged at the mixer start 25. The compressed air is conducted via the mixer passage for compressed air 30 to a mixer outlet for compressed air 32 which is located at the mixer end 26.

A static mixing element 33 which serves for mixing the two components is arranged within the inner mixer housing 29. The mixing element 33 is made in one piece with a mixer inlet opening 34 via which a first component can be supplied to the spray mixer 22. The mixing element 33 has a second mixer inlet opening via which a second component can be supplied. It is, however, not in the sectional plane shown so that this second mixer inlet opening is not shown in FIG. 2. The mixer inlet opening 34 has a circular cross-section and likewise forms a part of the mixer inlet connector 27.

The two mixer inlet openings are connected to corresponding cartridge outlet openings, with only one cartridge outlet opening 36 being visible in FIG. 2 which is connected to the mixer inlet opening 34. The cartridge outlet opening 36 is part of the cartridge outlet connector 28.

At the mixer end 26, the inner mixer housing 29 has a mixer outlet opening 35 via which the components mixed by the mixing element 33 can exit the inner mixer housing 29. The mixer outlet for compressed air 32 is arranged around the mixer outlet opening 35. The mixed components exiting the mixer outlet opening 35 are thus atomized and sprayed. In addition, grooves or similar can also be arranged in the region of the mixer outlet opening 35 and of the mixer outlet for compressed air 32 which provide a swirling of the compressed air and thus an effective atomization of the mixed components.

The mixer inlet for compressed air 31 is connected to a cartridge outlet for compressed air 37 of the multicomponent cartridge 10 which provides the cartridge passage for compressed air 20 with compressed air. The cartridge passage for compressed air 20 kinks in the direction of the longitudinal mixer axis 24 for this purpose. The mixer inlet for compressed air 31 and the cartridge outlet for compressed air 37 have a ring-shaped cross-section and are arranged around the mixer inlet openings 34 and the cartridge outlet openings 36. The mixer inlet for compressed air 31 is in this respect a part of the mixer inlet connector 27 and the cartridge outlet for compressed air 37 is a part of the cartridge outlet connector 28.

The components and the compressed air flow from the cartridge outlet connector 28 to the mixer inlet connector 27 along the longitudinal mixer axis 24. They are thus oriented in the direction of the longitudinal mixer axis 24.

The connection between the mixer inlet connector 27 and the cartridge outlet connector 28 is secured by a retainer nut 38 which is arranged around the mixer inlet for compressed air 31 and the cartridge outlet for compressed air 37. Other securing means are also possible instead of the retainer nut, such as a bayonet closure, for example.

The individual components of the spray mixer 22 are manufactured from plastic by means of an injection molding process. Polypropylene, polyamide, polycaprolactam (polyamide 6) or polybutylene terepththalate can likewise be used for this purpose, for example.

The multicomponent cartridge 10 is inserted into a dispensing device to dispense the components out of the containers 11, 12 of the multicomponent cartridge 10. A dispensing device 40 is shown in schematic form in a sectional representation in FIG. 3. The dispensing device 40 has a receiver element 41 for receiving a multicomponent cartridge. The receiver element 41 has a rectangular cross-section. A multicomponent cartridge can be inserted from above into the receiver element 41 via an opening, not shown, of the receiver element 41. The receiver element 41 has an opening 43 at a front side 42 of the dispensing device 40 which is positioned so that the cartridge outlet connector of the multicomponent cartridge can project through the opening 43.

The dispensing device 40 has a first actuation element 44 and a second actuation element 45. The first actuation element 44 is arranged so that it can displace the piston of the first container and thus actuate it with an inserted multicomponent cartridge. The second actuation element 45 is arranged so that it can displace the piston of the second container and thus actuate it with an inserted multicomponent cartridge. The two actuation elements 44, 45 each have an actuation rod 46, 47 which can be displaced in the direction of the opening 43 by means of compressed air.

The dispensing device 40 has a device outlet for compressed air 48 between the two actuation rods 46, 47, but arranged in a different plane. Since the device outlet for compressed air 48 is arranged in a different plane, it is shown by dashed lines in FIG. 3. The device outlet for compressed air 48 is arranged so that it is connected to the cartridge inlet for compressed air with an inserted multicomponent cartridge. The device outlet for compressed air 48 is connected to a device inlet for compressed air 50 by means of a device passage for compressed air 49. The dispensing device 40 can be connected to a customary compressed air supply via the device inlet for compressed air 50.

The device inlet for compressed air 50 is arranged at a device handle 51 which is connected to the receiver element 41. The device handle 51 serves to allow an operator to securely hold the dispensing device 40. In addition, an activation button 52 is arranged at the dispensing device 51 by means of which the operator can trigger the dispensing, mixing and spraying of the components.

1. A multicomponent cartridge for receiving flowable components which are to be applied using a spray process, comprising
a first container for receiving a first component;
a second container for receiving a second component;
at least one cartridge outlet opening via which the components can exit the containers, and
a cartridge passage for compressed air guided along the containers, the cartridge passage for compressed air having a cartridge inlet for compressed air and a cartridge outlet for compressed air,
wherein
the first container, the second container and the cartridge passage for compressed air are made in one piece.

2. The multicomponent cartridge in accordance with claim 1,
which
the first container is cylindrical and has a first cylinder axis; and
the second container is likewise cylindrical and has a second cylinder axis; and
the first and second containers are arranged paraxially next to one another and the cartridge passage for compressed air is arranged between the first and second cylinder axes.

3. The multicomponent cartridge in accordance with claim 2,
in which
the first container and the second container are arranged so that a notch is formed between them, the notch extending in parallel to the cylinder axes and the cartridge passage for compressed air being arranged in the named notch.

4. The multicomponent cartridge in accordance with claim 1,
in which
the first container and the second container have filling openings and the filling openings and the cartridge inlet for compressed air are arranged in one plane.

5. The multicomponent cartridge in accordance with claim 1,
in which
the first container, the second container and the cartridge passage for compressed air are made from plastic.

6. The multicomponent cartridge in accordance with claim 1,
in which
the first container, the second container and the cartridge passage for compressed air are manufactured in an injection molding process.

7. The multicomponent cartridge in accordance with claim 1,
further comprising
a cartridge outlet connector, wherein a spray mixer can be connected to the cartridge outlet connector and wherein the cartridge outlet connector surrounds the cartridge outlet for compressed air.

8. The multicomponent cartridge in accordance with claim 7,
in which the cartridge outlet connector has separate container outlet openings for the first and second containers.

9. A dispensing device for a multicomponent cartridge comprising
a receiver element for a multicomponent cartridge having a first container for receiving a first flowable component and a second container for receiving a second flowable component;
a first actuation element for a first piston of the first container;
a second actuation element for a second piston of the second container; and
a device passage for compressed air having a device inlet for compressed air and a device outlet for compressed air, with the device passage for compressed air being designed such that it can be connected to a cartridge inlet for compressed air of the multicomponent cartridge.

10. The dispensing device in accordance with claim 9,
in which
the first actuation element has a first actuation rod;
the second actuation element has a second actuation rod; and
the device outlet for compressed air is arranged between the first actuation rod and the second actuation rod.

11. A system for mixing and spraying flowable components comprising
a multicomponent cartridge with
a first container for receiving a first component;
a second container for receiving a second component; and
at least one outlet opening via which the components can exit from the containers;
a dispensing device with
a receiver element for the multicomponent cartridge;
a first actuation element for a first piston of the first container; as well as with
a second actuation element for a second piston of the second container; and
a spray mixer connected to the outlet opening of the multicomponent cartridge,
in which
the multicomponent cartridge has a cartridge passage for compressed air with a cartridge inlet for compressed air and a cartridge outlet for compressed air; and
the dispensing device has a device passage for compressed air with a device inlet for compressed air and a device outlet for compressed air, wherein the cartridge inlet for compressed air and the device outlet for compressed air are designed so that they are connected to one another when the multicomponent cartridge is inserted into the receiver element of the dispensing device.

12. The system in accordance with claim 11,
in which
the spray mixer has
a tubular outer mixer housing that extends in the direction of a longitudinal mixer axis from a mixer start up to a distal mixer end, the tubular outer mixer housing having a mixer outlet opening for the components;
at least one mixing element arranged in the outer mixer housing for mixing the components; and
a mixer passage for compressed air that extends from a mixer inlet for compressed air to the mixer outlet opening,
wherein the mixer inlet for compressed air is arranged at the mixer start.

13. The system in accordance with claim 12,
further comprising
an inner mixer housing that is arranged within the outer mixer housing and that receives the mixing element; and the mixer passage for compressed air is formed between the inner mixer housing and the outer mixer housing.

14. The system in accordance with claim 12,
in which
the spray mixer has a mixer inlet connector which
can be connected to the cartridge outlet connector of the multicomponent cartridge;
has at least one mixer inlet opening via which the components can be supplied; and
includes the mixer inlet for compressed air.
